(19) United States
(12) Patent Application Publication
(10) Pub. No.: US 2025/0094096 A1
(43) Pub. Date: Mar. 20, 2025

(54) IMAGE FORMING APPARATUS, METHOD FOR CONTROLLING IMAGE FORMING APPARATUS, AND STORAGE MEDIUM

(71) Applicant: CANON KABUSHIKI KAISHA, Tokyo (JP)

(72) Inventor: Ryo Degawa, Ibaraki (JP)

(21) Appl. No.: 18/823,792

(22) Filed: Sep. 4, 2024

(30) Foreign Application Priority Data
Sep. 19, 2023 (JP) 2023-151543

(51) Int. Cl. G06F 3/12

(52) U.S. Cl. CPC G06F 3/1205; G06F 3/1258

(57) ABSTRACT

An image forming apparatus comprises: a first setting unit configured to set adjustment values for image formation to a sheet feeding unit; a second setting unit configured to set adjustment values for image formation to a sheet; and a control unit. The control unit controls to form an image on the sheet using the adjustment values for image formation set to the sheet by the second setting unit when the adjustment values for image formation have been set to the sheet by the second setting unit, and to perform control to form an image on the sheet using the adjustment values for image formation set to the sheet feeding unit by the first setting unit when the adjustment values for image formation have not been set to the sheet by the second setting unit.

### BACKGROUND OF THE INVENTION

### Field of the Invention

The present invention relates to an image forming apparatus, a method for controlling an image forming apparatus, and a storage medium.

### Description of the Related Art

It is known that when printing is performed using a printing machine, the printing position of an image to be printed may become skewed or the printing positions of images on the front and back sides of a sheet of paper may become slightly misaligned due to several factors. Factors that cause misalignment can be classified into two main categories. The first factor is the difference in expansion and contraction due to the characteristics of the sheet of paper. In electrophotographic printing machines, an image is fixed to the sheet of paper by passing the sheet of paper with the developed and transferred toner through a fixing unit. When the sheet of paper passes through the high-temperature fixing unit, the sheet of paper expands and contracts, which may cause the printing positions of the images on the front and back of the sheet of paper to become misaligned. The way the sheet of paper expands and contracts varies depending on the characteristics of the sheet of paper, such as differences in grammage, surface property, size, etc. of the sheet of paper.

The second factor is the differences in the structures of a paper feeding unit, in which sheets of paper are stored, and a transport unit. Differences in the structure of the paper feeding unit, which feeds a sheet of paper, and the transport unit, which transports the sheet of paper during printing, may cause the timing of the print start position to deviate or the sheet of paper to be slightly skewed. Such deviations differ from one paper feeding unit to another.

To address a printing position misalignment of an image caused by the above factors, there is a known conventional method in which adjustment values for adjusting the image position are stored in a printing system and used for adjustment. As a measure against the first factor, for example, a method of having adjustment values for each piece of paper information is known. As a measure against the first factor, for example, a method of having adjustment values for each paper feeding unit is known. In addition, in a printing system that includes an image processing apparatus and an image forming apparatus, a system in which each apparatus has the above-mentioned two different methods is known.

In both of the above-mentioned measures, a test page for adjustment is printed using any sheet of paper and paper feeding unit that are the targets of adjustment, and the adjustment values are determined based on the results. By adjusting the position of the image to be printed based on the determined adjustment values, the printing system can print the image in the correct printing position without any misalignment.

Japanese Patent Laid-Open No. 2016-16588 proposes a system in which, when image position adjustment is performed based on adjustment values for each piece of paper information, the adjustment values for each paper feeding unit that houses the sheet of paper for which the image position adjustment has been performed are initialized. In the conventional technology, when adjustment values for each piece of paper information and adjustment values for each paper feeding unit coexist, the adjustment values for each piece of paper information are given priority.

When paper information is newly created and image position adjustment has not been performed, the image position adjustment values for each piece of paper information remain the initial values. In conventional printing systems, image formation is performed using the adjustment values for each piece of paper information, regardless of whether or not the adjustment values for the paper feeding unit have been adjusted. Therefore, when a sheet of paper for which image position adjustment has not been performed is loaded onto a paper feeding unit for which the adjustment values for the paper feeding unit have been adjusted, there is a problem in that unadjusted initial values for the piece of paper information are set even if the adjustment values for the paper feeding unit have been adjusted.

### SUMMARY OF THE INVENTION

The present invention enables realization of a mechanism that, when image formation adjustment values have been set for a sheet, performs control to form an image on the sheet using the image formation adjustment values set for the sheet, and when no image formation adjustment values have been set for the sheet, performs control to form an image on the sheet using image formation adjustment values set for a sheet feeding unit.

One aspect of the present invention provides an image forming apparatus comprising: at least one processor that causes the image forming apparatus to function as: a first setting unit configured to set one or more adjustment values for image formation to a sheet feeding unit; a second setting unit configured to set one or more adjustment values for image formation to a sheet; and a control unit configured to perform control to form an image on the sheet using the adjustment values for image formation set to the sheet by the second setting unit in the case where the adjustment values for image formation have been set to the sheet by the second setting unit, and to perform control to form an image on the sheet using the adjustment values for image formation set to the sheet feeding unit by the first setting unit in the case where the adjustment values for image formation have not been set to the sheet by the second setting unit.

Another aspect of the present invention provides a control method for controlling an image forming apparatus, the control method comprising: a first setting step of setting one or more adjustment values for image formation to a sheet feeding unit; a second setting step of setting one or more adjustment values for image formation to a sheet; and a control step of performing control to form an image on the sheet using the adjustment values for image formation set to the sheet in the second setting step in the case where the adjustment values for image formation have been set to the sheet in the second setting step, and performing control to form an image on the sheet using the adjustment values for image formation set to the sheet feeding unit in the first setting step in the case where the adjustment values for image formation have not been set to the sheet in the second setting step.

Still another aspect of the present invention provides a non-transitory computer readable storage medium that stores a computer program for causing a computer to perform a control method for controlling an image forming apparatus, the control method comprising: a first setting step of setting one or more adjustment values for image formation to a sheet feeding unit; a second setting step of setting one or more adjustment values for image formation to a sheet; and a control step of performing control to form an image on the sheet using the adjustment values for image formation set to the sheet in the second setting step in the case where the adjustment values for image formation have been set to the sheet in the second setting step, and performing control to form an image on the sheet using the adjustment values for image formation set to the sheet feeding unit in the first setting step in the case where the adjustment values for image formation have not been set to the sheet in the second setting step.

### BRIEF DESCRIPTION OF THE DRAWINGS

FIG. 1 is a diagram showing a configuration of a system according to an embodiment.

FIG. 2 is a diagram showing a hardware configuration of a printer according to an embodiment.

FIG. 3 is a diagram showing a configuration of a software module for a printer according to an embodiment.

FIG. 4 is an example of a structure of a paper information database according to an embodiment.

FIG. 5 is an example of a UI that is used to perform paper information registration according to an embodiment.

FIG. 6A is an example of a UI that is used to edit paper attribute information according to an embodiment.

FIG. 6B is an example of a data structure of paper information.

FIG. 7 is an example of a UI that is used to perform paper setting according to an embodiment.

FIGS. 8A and 8B are examples of UIs that are used to perform paper setting according to an embodiment.

FIG. 9 is an example of a flow of processing that is performed to adjust an image position for each piece of paper information according to an embodiment.

FIGS. 10A to 10E are examples of UIs that are used to adjust an image position for each piece of paper information according to an embodiment.

FIG. 11 is an example of a flow of processing that is performed to adjust an image position for each paper feeding unit according to an embodiment.

FIGS. 12A to 12E are examples of UIs that are used to adjust an image position for each paper feeding unit according to an embodiment.

FIG. 13 is an example of a data structure of paper feeding unit information according to an embodiment.

FIG. 14 is an example of a flow of processing that is performed to determine image position adjustment values according to an embodiment.

FIG. 15 is an example of a flow of processing that is performed to initialize adjustment values for each piece of paper information according to an embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

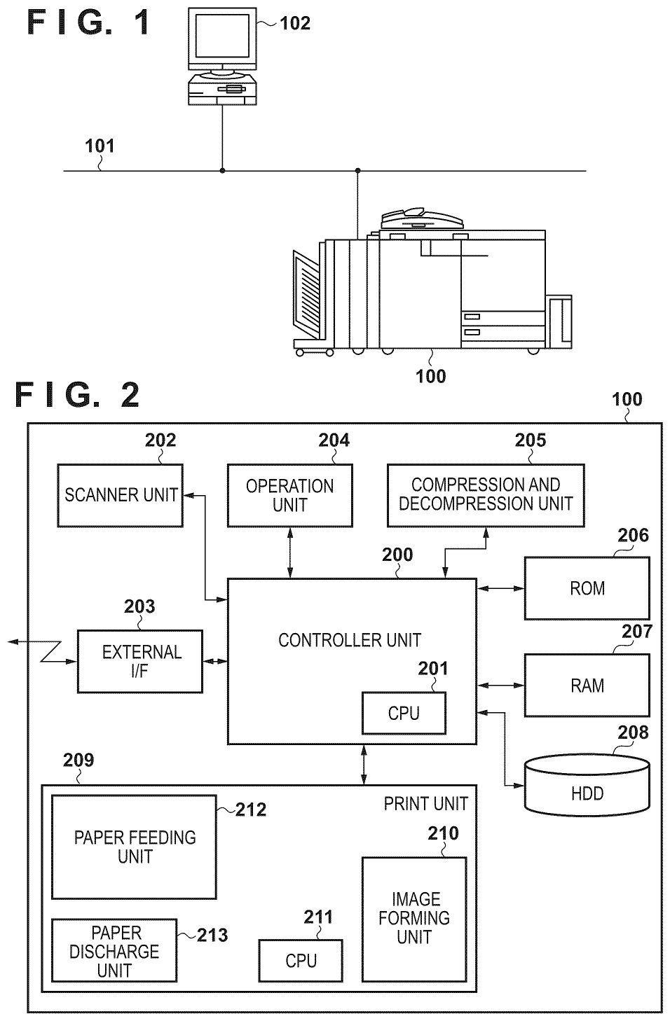

A connection environment of an image forming apparatus according to the present embodiment will be described with reference to FIG. 1. In the present embodiment, a printer 100 and a client PC 102 are connected to each other via a network line 101. Note that in the present embodiment, the image forming apparatus is referred to as a “printer”. However, the image forming apparatus is not limited to a printer, and may be an MFP (multifunction printer) or an SMP (single function printer) equipped with one or more or all of various functions such as copying, scanning, and faxing functions. In the present embodiment, a print job corresponding to a print instruction entered by a user from the client PC 102 is transmitted from a printer driver (not shown) to the printer 100 via the network line 101. Furthermore, the printer 100 performs the necessary processing for the received print job and performs printing on a sheet of paper.

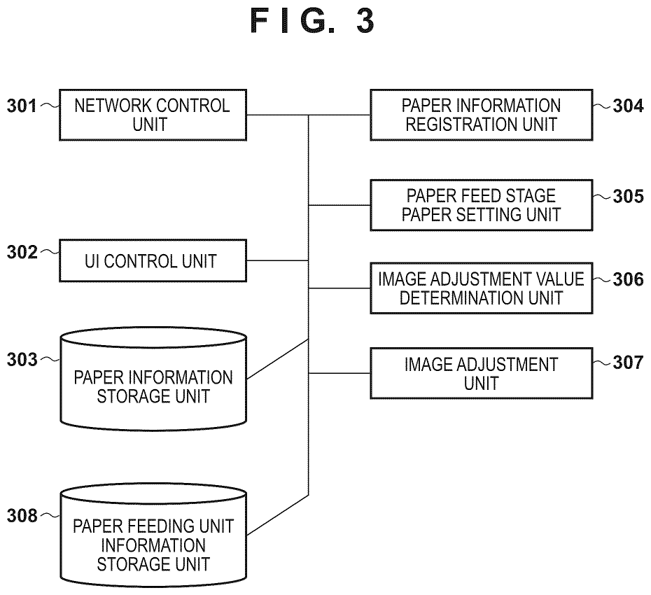

A hardware configuration of the printer 100 according to the present embodiment will be described with reference to FIG. 2. The printer 100 includes a controller unit 200 that includes a CPU 201, a scanner unit 202, an external I/F 203, an operation unit 204, a compression and decompression unit 205, a ROM 206, a RAM 207, an HDD 208, and a print unit 209. Various control programs controlled by the controller unit 200 are stored in the ROM 206, and are loaded into the RAM 207 as necessary and controlled and executed by the CPU 201. Furthermore, the print unit 209 includes an image forming unit 210, a CPU 211, a paper feeding unit 212 that includes a plurality of paper feed stages, and a paper discharge unit 213. The paper feeding unit 212 includes at least two paper feed stages.

A software module configuration of the printer 100 according to the present embodiment will be described with reference to FIG. 3. The printer 100 includes a network control unit 301, a UI control unit 302, a paper information registration unit 304, a paper feed stage paper setting unit 305, an image adjustment value determination unit 306, and an image adjustment unit 307 as software modules. Furthermore, the HDD 208 includes a paper information storage unit 303 and a paper feeding unit information storage unit 308 as storage units. Each software module is stored in the ROM 206 of the printer 100 as a program, and is loaded into the RAM 207 as necessary and is controlled and executed by the CPU 201 or CPU 211.

The network control unit 301 is executed by the CPU 201, and transmits and receives data to and from the client PC 102 via the external I/F 203 and the network line 101. The UI control unit 302 is executed by the CPU 201, and instructs the operation unit 204 to generate, display, and change display contents.

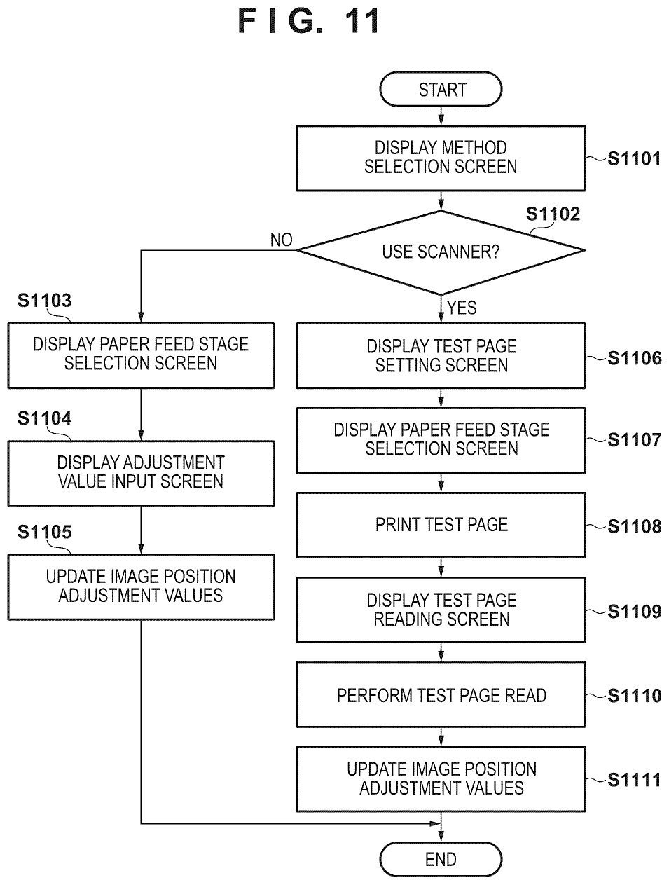

The paper information storage unit 303 functions as the first storage unit, and is stored in the HDD 208. The CPU 201 stores paper information registered by the paper information registration unit 304, which will be described later, in the paper information storage unit 303, and writes, reads, and uses the information as necessary. The paper information stored in the paper information storage unit 303 includes paper information that has been created and pre-installed by the printer manufacturer, and paper information that has been newly created and added by the user using the method described later. The paper feeding unit information storage unit 308 functions as the second storage unit, and is stored in the HDD 208. The CPU 201 stores an image position adjustment value for each paper feeding unit in the paper feeding unit information storage unit 308 according to the flow of image position adjustment for each paper feeding unit described later (FIG. 11), and writes reads, and uses the values as necessary.

The paper information registration unit 304 is executed by the CPU 201 and functions as the second setting unit, and registers the paper information to be used in the printer 100. The CPU 201 receives paper information input by the user from the operation unit 204 via the UI control unit 302, and stores the information in the paper information storage unit 303. The CPU 201 displays the information on the operation unit 204 via the UI control unit 302.

The paper feed stage paper setting unit 305 is executed by the CPU 201 and functions as the first setting unit, and sets the paper information to be used in the printer 100 to the paper feed stages. The CPU 201 receives paper setting information for paper feed stages input by the user via the operation unit 204, and stores the information in the RAM 207 or the HDD 208. The CPU 201 displays the information on the operation unit 204 via the UI control unit 302. When performing printing, the CPU 201 determines the printing operation of the image forming unit 210 based on the paper information set to the paper feed stages. For example, in the case of a sheet of paper with a large grammage, the image forming unit 210 operates to reduce the paper transport speed and increase the fixing temperature.

The image adjustment value determination unit 306 is executed by the CPU 201 and determines adjustment values for adjusting an image printing position misalignment that occurs in the printer 100 during printing. The image adjustment unit 307 is executed by the CPU 201, and executes position misalignment adjustment processing based on the adjustment values determined by the image adjustment value determination unit 306, thereby adjusting the image position on the printing paper.

A common method of adjusting the image position is to adjust the rendering position of the image data based on adjustment values when the print data is processed in the controller unit 200 of the printer 100. There is also a method of adjusting the control timing of each device (not shown) executed in the image forming unit 210 of the printer 100 based on adjustment values.

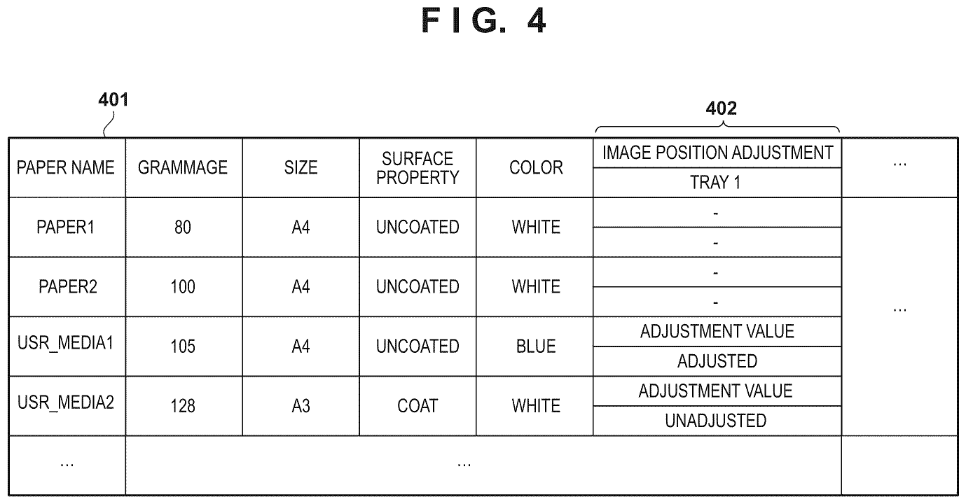

FIG. 4 shows an example of the structure of a database 401 showing the pieces of paper information stored in the paper information storage unit 303 according to the present embodiment. The CPU 201 stores paper attribute information registered by the paper information registration unit 304 in the paper information database 401. In the example of the paper information database 401 shown in FIG. 4, “PAPER1” and “PAPER2” respectively indicate pieces of paper information regarding basic papers that are created and pre-installed by the printer manufacturer. On the other hand, “USR_MEDIA1” and “USR_MEDIA2” are pieces of paper information for user-defined papers newly created and added by the user.

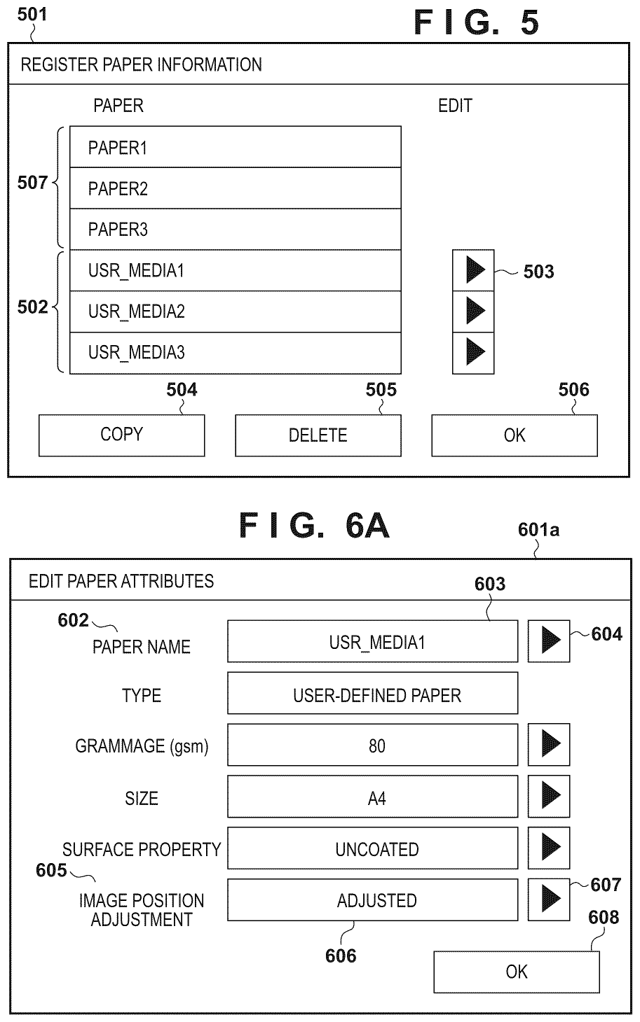

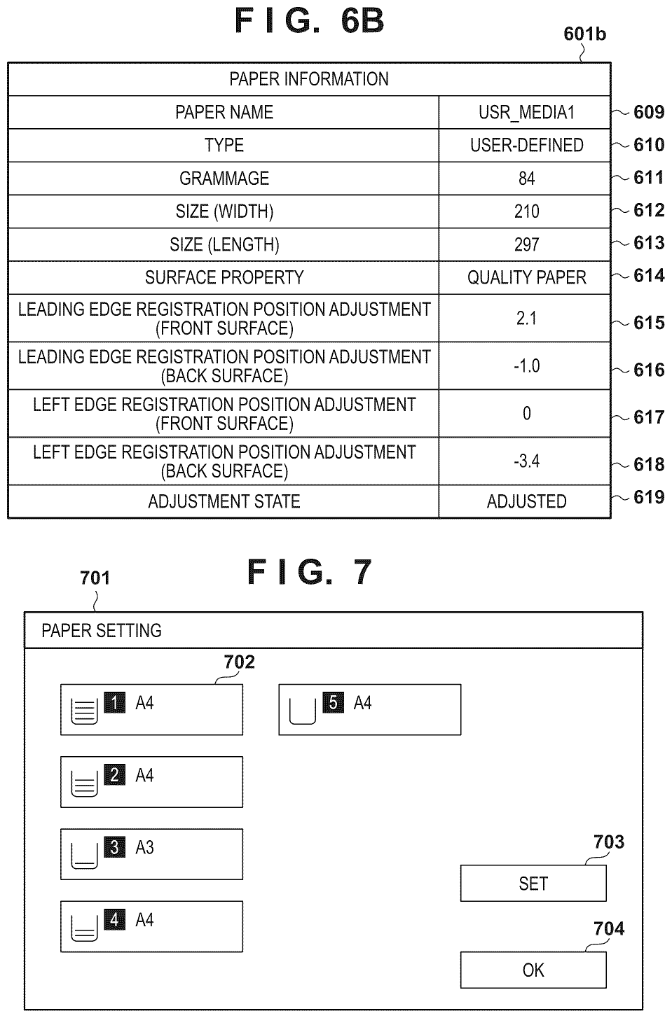

Registration of user-defined papers will be described later with reference to FIGS. 5, 6A, and 6B. In the paper information database 401, paper attribute information such as the grammage, size, surface property, and color is registered in association with the paper name. The present embodiment is characterized in that the paper information database 401 includes image position adjustment information 402 as paper attribute information. The image position adjustment information 402 is formed to store image position adjustment values and information regarding whether the image position is “adjusted” or “unadjusted” for each user-defined paper.

### Paper Information Registration and Editing

A registration screen of the paper information registration unit 304 according to the present embodiment will be described with reference to FIG. 5. A paper information registration screen 501 is generated by the UI control unit 302 and displayed on the operation unit 204 when a paper information registration instruction is given by the user from a basic screen (not shown). The UI control unit 302 displays information regarding the paper information database 401 stored in the paper information storage unit 303 on the operation unit 204. Although the paper name included in the paper information is displayed in this example, information other than the paper name may be displayed as long as it is information that can identify the individual paper.

The paper information list on the registration screen in FIG. 5 shows a list of basic papers 507 and a list of user-defined papers 502. Furthermore, the UI control unit 302 displays, for each piece of paper information in the list of user-defined papers 502, a button 503 used to edit the attribute information of the piece of paper information, which will be described later. The user-defined papers 502 are papers whose types 610 (FIGS. 6A and 6B), which will be described later, are registered as “user-defined”.

When the edit button 503 for any user-defined paper is operated by the user, the UI control unit 302 displays, on the operation unit 204, a paper attribute edit screen 601a (FIG. 6A), which will be described later. A copy button 504 is a button used to create new paper information based on the paper information regarding the selected basic paper 507 and storing it in the paper information storage unit 303.

When the copy button 504 is operated by the user, the CPU 201 creates new paper information using the same paper information as the selected basic paper 507, and stores the information in the paper information storage unit 303 as information regarding the user-defined paper 502. When the copy button 504 is operated based on the user-defined paper 502, regarding an adjustment state 619 (FIG. 6B) described later, the adjustment state of the original is copied as well as the same paper information as the basic paper.

In addition, the UI control unit 302 displays the information as a paper information list on the paper information registration screen 501. A delete button 505 is a button used to delete any user-defined paper information.

When the delete button 505 is pressed by the user with arbitrary paper selected from the list of user-defined papers 502, the CPU 201 deletes the selected paper information from the paper information storage unit 303. In addition, the UI control unit 302 deletes the information from the list of user-defined papers 502.

When an OK button 506 is pressed by the user, the UI control unit 302 closes the paper information registration screen 501 and transitions to the basic screen (not shown). The basic paper 507 is created in advance and pre-installed by the printer manufacturer, and the basic paper is set as the type 610 (FIG. 6B) described later. For the basic paper 507, the paper information cannot be deleted using the delete button 505 or edited using the edit button 503.

Editing of paper attributes of paper information according to the present embodiment and the data structure of paper information including image position adjustment attributes will be described with reference to FIGS. 6A and 6B. The paper attribute editing screen 601a in FIG. 6A is generated by the UI control unit 302 and displayed on the operation unit 204. When the edit button 503 for any paper on the paper information registration screen 501 is operated by the user, the UI control unit 302 displays the paper attribute edit screen 601a based on the paper attribute information of the selected user-defined paper stored in the paper information storage unit 303.

The items displayed here include, in addition to information indicating that a paper name 602 is USR_MEDIA1 (603), information regarding the paper settings required for the printer 100 to operate, such the type, grammage, size, surface property, and image position adjustment (605). In addition to these items, other paper characteristics such as color and other individual information may be registered and displayed.

An edit button 604 is provided for each item, and when the edit button 604 is operated by the user, the UI control unit transitions to a screen (not shown) that receives an input for the corresponding item, and after receiving the input, returns to the paper attribute edit screen 601a. In the present embodiment, the type of paper information cannot be changed, but it may be possible to change the type, for example, by setting a different type for each user.

The CPU 201 stores the received input information in the paper information storage unit 303, and the UI control unit 302 updates the information and displays it on the paper attribute edit screen 601a. The operations with buttons 605 to 607 relating to image position adjustment will be described later. When an OK button 608 is operated by the user, the UI control unit 302 closes the paper attribute edit screen 601a and returns to the paper information registration screen 501.

The data structure of paper information will be described with reference to FIG. 6B. Paper information 601b stores a paper name 609, a type 610, a grammage 611, a size (width) 612, a size (length) 613, and a surface property 614. Furthermore, the paper information 601b stores an adjustment value 615 for the leading edge registration point of the front side, an adjustment value 616 for the leading edge registration point of the back side, an adjustment value 617 for the left edge registration point of the front side, an adjustment value 618 for the leading edge registration point of the back side, and the adjustment state 619. In addition, information specific to each paper type, such as the color of the paper, may be stored.

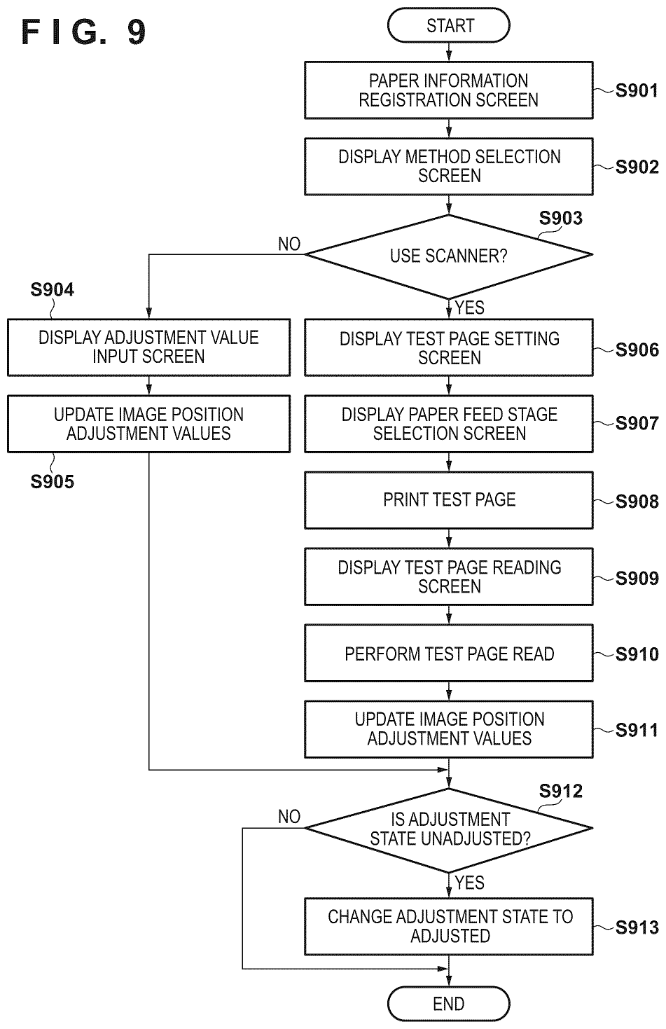

When a user-defined paper sheet is created and image position adjustment is not performed, the adjustment values 615, 616, 617, and 618 for the items are the initial values, and the adjustment state 619 is unadjusted. Image position adjustment is performed according to the flow of image position adjustment for each piece of paper information (FIG. 9) described later, the adjustment values are stored in the adjustment values 615, 616, 617, and 618 for the items, and the adjustment state 619 becomes “adjusted”. In the present embodiment, the leading edge registration and the left edge registration are taken as examples, but adjustment values for adjusting the magnification, skew, right angles, trapezoidal shape, and the like may also be stored. The adjustment values 615 to 618 are pieces of information relating to the image position adjustment 605 in FIG. 6A.

### Paper Feed Stage Paper Setting

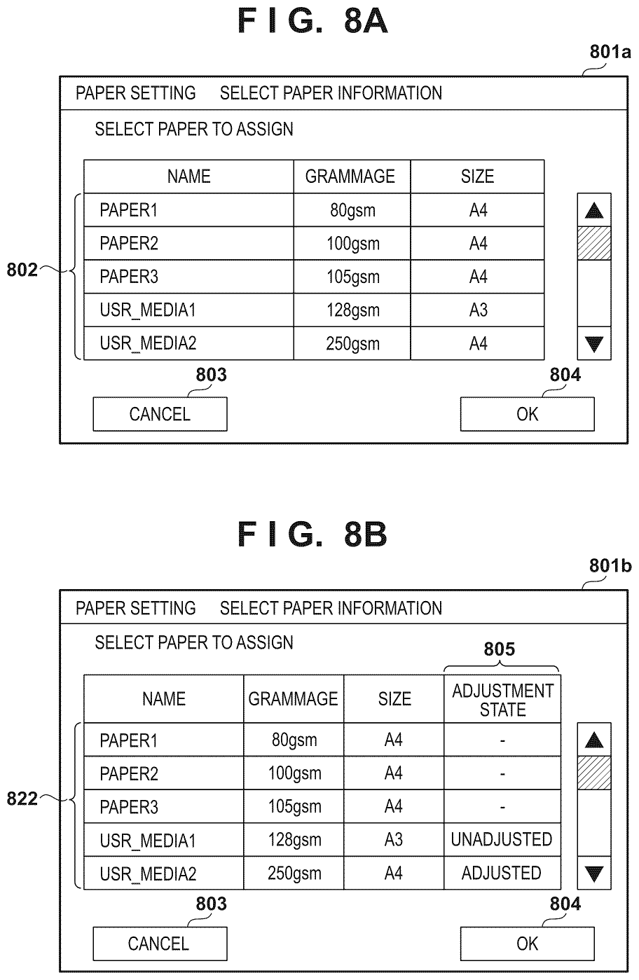

The paper setting performed by the paper feed stage paper setting unit 305 according to the present embodiment will be described with reference to FIGS. 7, 8A, and 8B. A paper setting screen 701 shown in FIG. 7 is generated by the UI control unit 302 and displayed on the operation unit 204 when a paper feed stage paper setting instruction is given by the user from the basic screen (not shown). The UI control unit 302 displays a plurality of pieces of paper feed stage information held by the paper feeding unit 212 connected to the printer 100 and pieces of paper information set for the paper feed stages in the fields indicated by the reference numeral 702. In FIG. 7, information regarding the remaining amount of paper controlled by the CPU 201, information regarding the paper feed stage number, and information regarding the set paper size are displayed. In addition, information regarding the set paper name and grammage may also be displayed.

A button 703 is a setting button. When the setting button 703 is operated by the user with any paper feed stage 702 selected, the UI control unit 302 displays a paper information selection screen 801a and 801b, which will be described later. On this screen, the user selects the paper information that the user wishes to set to the paper feed stage. The CPU 201 stores the paper information selected by the user in the RAM 207 or the HDD 208 in combination with the paper feed stage information, and the UI control unit 302 displays the selected paper information in the field indicated by the reference numeral 702. When an OK button 704 is operated by the user, the UI control unit 302 closes the paper setting screen 701 and transitions to the basic screen (not shown).

A paper information selection screen 801a in FIG. 8A is generated by the UI control unit 302 and displayed on the operation unit 204 when the setting button 703 is operated with any paper feed stage 702 selected in FIG. 7. The UI control unit 302 displays the list of the paper information database 401 database 401 stored in the paper information storage unit 303 on the area indicated by the reference numeral 802.

In FIG. 8A, the name, grammage, and size included in the registered paper information are displayed as examples, but other attribute information of the paper information, such as surface property and color, may also be displayed. FIG. 8B shows another example of the paper information selection screen 801b. A paper information selection screen 801b displays an image position adjustment state 805 in addition to the display items on the paper information selection screen 801a. As a result, the user can grasp whether each of the image adjustment values for the pieces of paper information to be set to the paper feed stage is “adjusted” or “unadjusted”.

When an OK button 804 is selected by the user with one piece of paper information to be set to the paper feed stage selected from the list 802, the CPU 201 stores the selected piece of paper information in the RAM 207 or the HDD 208 according to the flow described later (FIG. 9). Thereafter, the UI control unit 302 closes the paper information selection screen 801a and 801b and returns to the paper setting screen 701. On the other hand, when a cancel button 803 is selected by the user, the UI control unit 302 closes the paper information selection screen 801a and 801b without storing any paper information, and returns to the paper setting screen 701.

### Method for Adjusting Image Position for Each Piece of Paper Information

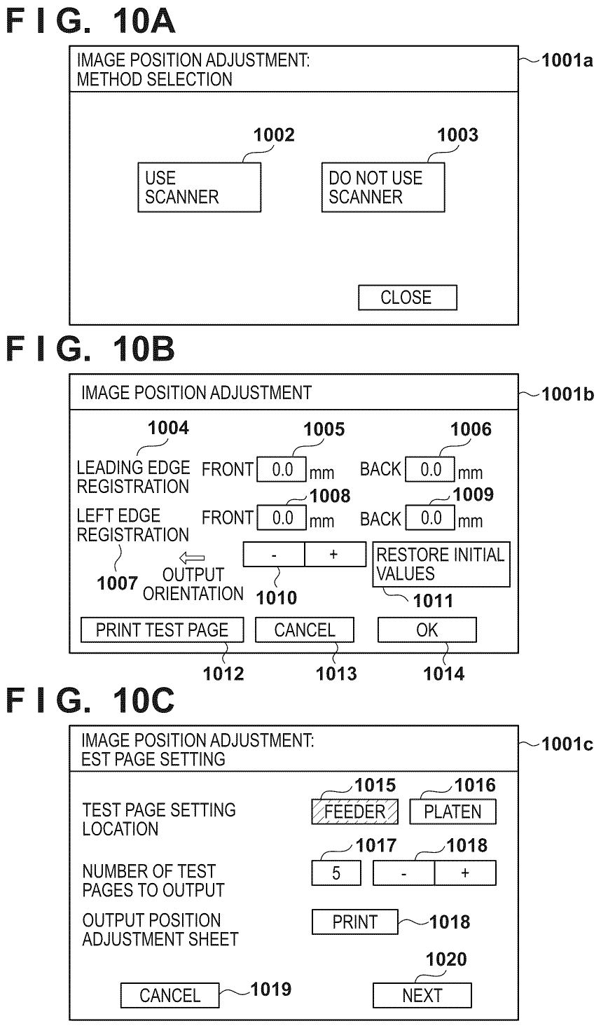

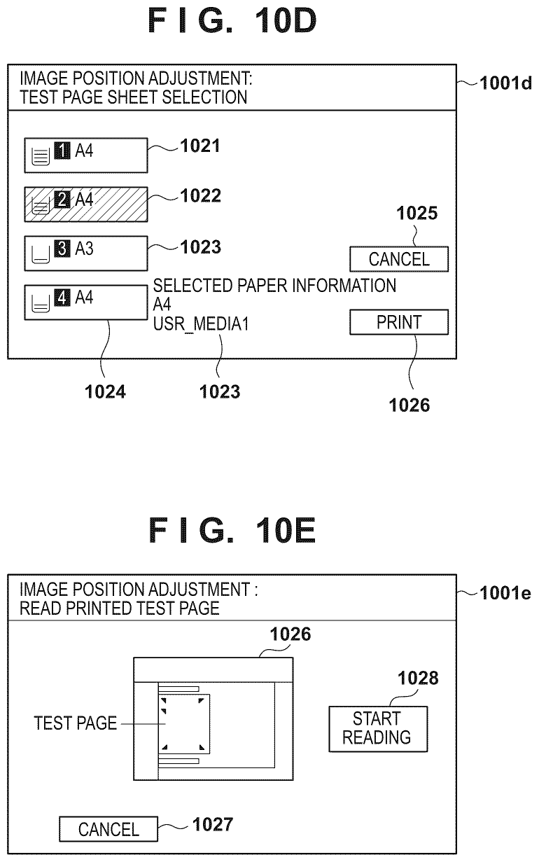

Next, processing that is performed to set image adjustment values for each piece of paper information according to the present embodiment will be described with reference to FIGS. 9 and 10A to 10E.

The processing described below is realized, for example, by the CPU 201 of the controller unit 200 loading a program stored in the ROM 206 into the RAM 207 and executing the program. In the following description, the step numbers of processing included in the flowchart will be indicated with numbers beginning with “S”. The same applies to the subsequent flowcharts.

In step S901, the CPU 201 displays the paper information registration screen 501 (FIG. 5) generated by the UI control unit 302 on the operation unit 204. This screen receives an input from the user, and when the edit button 503 is operated, processing proceeds to step S902.

In step S902, the CPU 201 displays a selection screen 1001a (FIG. 10A) used to select an image position adjustment method, generated by the UI control unit 302, on the operation unit 204. The screen 1001a displays a button 1002 for using the scanner and a button 1003 for not using the scanner, and receives an input from the user. If the user wishes to adjust the image position by entering adjustment values, the user selects the button 1003 for not using the scanner, while if the user wishes to adjust the image position automatically, the user selects the button 1002 for using the scanner.

In step S903, the CPU 201 determines whether the button 1002 for using the scanner or the button 1003 for not using the scanner on the screen 1001a has been operated. If it is determined that the button 1002 for not using the scanner has been operated (NO), processing proceeds to step S904, and if it is determined that the button 1003 for using the scanner has been operated (YES), processing proceeds to step S906.

In step S904, the CPU 201 displays the image position adjustment screen 1001b (FIG. 10B) generated by the UI control unit 302 on the operation unit 204, and receives an input from the user. The CPU 201 determines the amount of adjustment for adjusting the vertical and horizontal misalignment of the image to be printed on the printing paper, based on an input from the user. The reference numeral 1004 indicates an item used to adjust the leading edge registration point, and the UI control unit 302 displays the amount of adjustment for the front side and the back side in the area indicated by the reference numerals 1005 and 1006, respectively. The reference numeral 1007 indicates an item used to adjust the left edge registration point, and the UI control unit 302 displays the amount of adjustment for the front side and the back side in the area indicated by the reference numerals 1008 and 1009, respectively.

The UI control unit 302 receives an input of the adjustment amount in response to buttons 1010 being operated.

When the user operates the + or − button of the buttons 1010 while selecting any one of the items 1005, 1006, 1008, and 1009 that user wishes to adjust, the UI control unit 302 increments or decrements the value of the selected item by 0.1 and displays the result. Here, the adjustment amount is expressed as mm, the adjustment interval as 0.1, and the initial values as 0.0, for example, but other units such as the number of pixels may be used, and other adjustment intervals and initial values may also be used. Although the leading edge registration and the left edge registration are described above as examples of adjustment items, other geometric characteristics such as magnification, skew, right angles, and trapezoidal shape and the like may also be adjusted.

A test page print button 1012 is a button used to print a test page. When the user operates the test page print button 1012, a test page is printed in which the print position has been adjusted based on the adjustment amount currently displayed on the image position adjustment screen 1001b. The user can set adjustment values by measuring the distance from the leading edge of the printing area of the printed test page to the leading edge of the paper, and operating the + or − button of the buttons 1010 based on the difference from the specified values. If necessary, the user can print the test page again to check whether or not the adjustment was made properly. The user repeats this procedure to set the adjustment values.

When an initialization button 1011 used to restore the initial values is operated by the user, the UI control unit 302 resets the values of the adjustment amounts 1005, 1006, 1008, and 1009 to restore their respective initial values. When a cancel button 1013 is operated by the user, the UI control unit 302 closes the image position adjustment screen 1001b and returns to the method selection screen 1001a. The initialization button 1011 is an example of an initialization operation unit.

In step S905, If the CPU 201 determines that an OK button 1014 has been selected, the CPU 201 sets the input values for the adjustment amounts 1005, 1006, 1008, and 1009 to the adjustment values 615 to 618 in the paper information 601b, and stores them in the paper information storage unit 303.

In step S912, the CPU 201 determines whether or not the adjustment state 619 of the paper information is “unadjusted”. If it is determined that the state is “adjusted”, processing ends without doing anything, and if it is determined that the state is “unadjusted”, processing proceeds to step S913. In step S913, the CPU 201 changes the adjustment state 619 from “unadjusted” to “adjusted”, stores the information in the paper information storage unit 303, and ends processing.

Next, a case will be described where the user selects the button 1002 to use the scanner on the method selection screen 1001a, the CPU 201 determines in step S903 that the scanner is to be used (YES), and processing proceeds to step S906. In step S906, the CPU 201 displays a test page setting screen 1001c (FIG. 10C) generated by the UI control unit 302 on the operation unit 204, and receives settings input from the user. Reference numerals 1015 and 1016 indicate settings for the setting locations where the test page is to be set, and are items for selecting whether to use the feeder or the platen when reading the printed test page from the scanner unit 202. In this embodiment, the default setting 1015 is selected to use the feeder.

Reference numerals 1017 and 1018 indicate settings for the number of test pages to be output. When the CPU 201 determines that a designation of a number for the output sheet count 1017 has been received and the + button or − button 1018 has been operated, the UI control unit 302 increments or decrements the output sheet count 1017 by 1 and displays the result. If there is a large variation in the image position, the adjustment accuracy improves as the number of test pages output increases. The reference numeral 1019 indicates an output button used to output a position adjustment sheet when a test page is read from the platen. If the CPU 201 determines that the button 1019 has been operated, the CPU 201 controls the printer 100 to print a position adjustment sheet.

If the CPU 201 detects that the cancel button 1020 has been operated, the CPU 201 closes the image position adjustment screen 1001c and returns to the method selection screen 1001a. If the CPU 201 detects that a next button 1021 has been operated, processing proceeds to step S907.

In step S907, the CPU 201 displays a test page paper selection screen 1001d (FIG. 10D) and receives from the user the selection of paper on which the test page is to be printed. The reference numerals 1022, 1023, 1024, and 1025 on the paper selection screen 1001d indicate selectable papers, and on the paper selection screen 1001d, the paper 1023 is selected, and the paper information 1026 of the selected paper is displayed. When the user operates a print button 1028 with the test page paper selected, processing proceeds to step S908. On the other hand, if the cancel button 1027 is operated, the CPU 201 instructs the UI control unit 302 to close the image position adjustment screen 1001d and return to the method selection screen 1001a.

In step S908, the CPU 201 performs control to print, from the printer 100, a number of test pages corresponding to the setting location set in step S906, the number being set in the test page output count 1017 on the setting screen 1001c, and thereafter processing proceeds to step S909. Here, the setting location set in step S906 is the feeder 1015 or the platen 1016.

In step S909, the CPU 201 displays a test page reading screen 1001e (FIG. 10E) on the operation unit 204. After the user places the printed test pages in the test page setting location (the feeder 1015 or the platen 1016) set in step S906, when the user operates a reading start button 1031, processing proceeds to step S910. On the other hand, if a cancel button 1030 is operated, the CPU 201 instructs the UI control unit 302 to close the image position adjustment screen 1001e and return to the method selection screen 1001a.

When the CPU 201 detects that the reading start button 1031 on the screen 1001e has been operated, in step S910, the CPU 201 reads the test pages from the setting location (the feeder 1015 or the platen 1016) of the scanner unit 202, and processing proceeds to step S911. In step S911, the CPU 201 and the image adjustment value determination unit 306 analyze the images on the test pages read in step S910 and update the image position adjustment values. The method of acquiring registration adjustment values by reading test pages for image position adjustment is a well-known technique, and therefore the description thereof will be omitted here. The CPU 201 stores the acquired registration adjustment values in the fields 1015, 1016, 1017, and 1018, stores them in the paper information storage unit 303, and processing proceeds to step S912. The processing in steps S912 and S913 is similar to the processing in the case where the button 1003 for not using the scanner is selected in step S903, and therefore the description thereof will be omitted.

### Method for Adjusting Image Position for Each Paper Feeding Unit

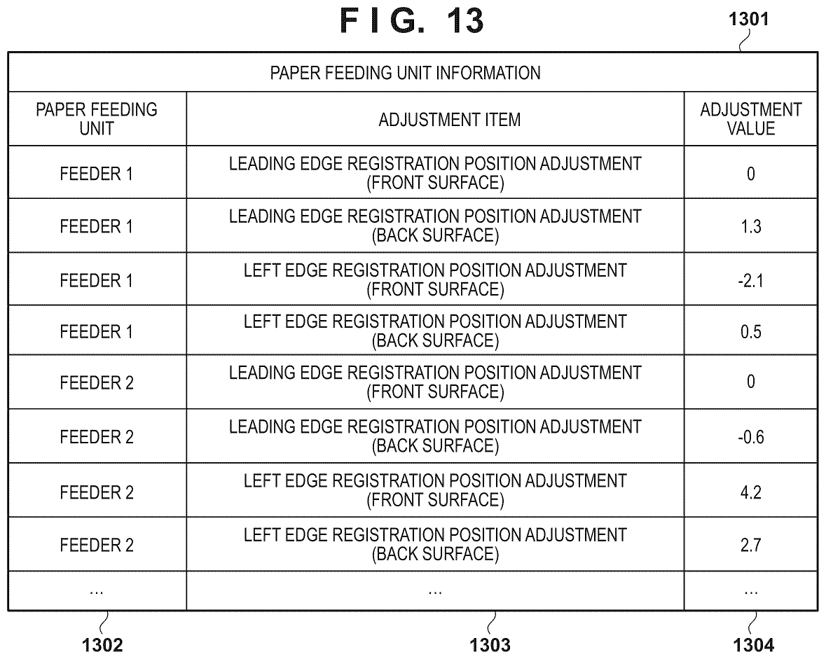

Next, processing performed to set image adjustment values or each paper feeding unit according to the present embodiment will be described with reference to FIGS. 11, 12A to 12E, and 13. The processing described below is realized, for example, by the CPU 201 of the controller unit 200 loading a program stored in the ROM 206 into the RAM 207 and executing the program. FIG. 13 shows an example of paper feeding unit information 1301, which is image position adjustment information for each paper feeding unit, stored in the paper feeding unit information storage unit 308. The paper feeding unit information 1301 stores adjustment values 1304 for adjustment items 1303 for each paper feeding unit 1302.

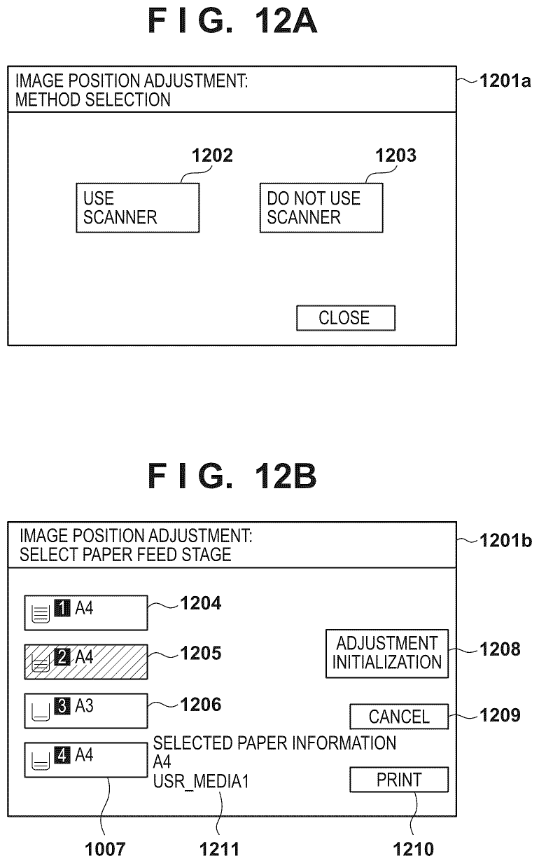

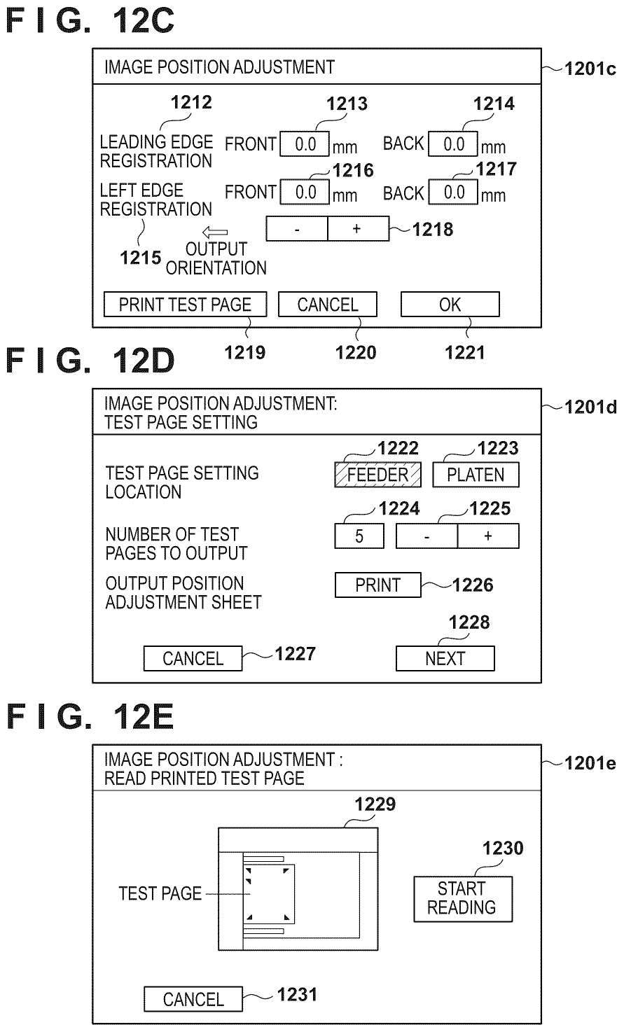

In step S1101, the CPU 201 displays on the operation unit 204 a selection screen 1201a (FIG. 12A) used to select one of the image position adjustment methods, which has been generated by the UI control unit 302. The image position adjustment methods are the same as those in the screen 1001b, and therefore the descriptions thereof will be omitted. In step S1102, the CPU 201 determines whether a button 1202 for using the scanner or a button 1203 for not using the scanner has been operated. If it is determined that the button 1203 for not using the scanner has been operated (NO), processing proceeds to step S1103, and if it is determined that the button 1202 for using the scanner has been operated (YES), processing proceeds to step S1106.

When the scanner is not to be used, in step S1103, the CPU 201 displays a paper feed stage selection screen 1201b (FIG. 12B) generated by the UI control unit 302 on the operation unit 204, and receives an input from the user. The reference numerals 1204, 1205, 1206, and 1207 indicate selectable paper feed stages, and the paper information set for the currently selected paper feed stage 1205 is displayed in the selected paper information 1211.

When the CPU 201 detects that a print button 1210 has been operated with any paper feed stage selected, the CPU 201 prints a test page from the printer 100 and processing proceeds to step S1104. This test page is used by the user to input adjustment values in step S1104. On the other hand, when the CPU 201 determines that a cancel button 1209 has been operated, the CPU 201 closes the paper feed stage selection screen 1201b and returns to the method selection screen 1201a.

When the CPU 201 detects that an adjustment initialization button 1208 has been operated with any paper feeding unit selected, the CPU 201 initializes the adjustment values 1304 of the adjustment items 1303 for the paper feeding unit 1302 in the paper feeding unit information 1301 corresponding to the selected paper feeding unit 1205 (paper feeding unit 2). Furthermore, the CPU 201 stores the initialized adjustment values 1304 in the paper feeding unit information storage unit 308. The adjustment items 1303 may include not only the leading edge registration adjustment values and the left edge registration adjustment values for the front and back sides, but also geometric adjustment values such as magnification adjustment values, right angle adjustment values, skew adjustment values, and trapezoid adjustment values, as well as other adjustment values associated with the paper feeding units and characteristics for each paper feeding unit.

In step S1104, the CPU 201 displays an image position adjustment screen 1201c (FIG. 12C) generated by the UI control unit 302 on the operation unit 204, and receives an input from the user. The image position adjustment screen 1201c is similar to the image position adjustment screen 1001b, and therefore the description thereof will be omitted. In step S1105, when an OK button 1221 on the image position adjustment screen 1201c is operated, the CPU 201 stores input adjustment values 1213, 1214, 1216, and 1217 in the adjustment values 1304 for the corresponding adjustment items 1303 in the paper feeding unit information 1301. Furthermore, the CPU 201 stores the paper feeding unit information 1301 in the paper feeding unit information storage unit 308, and ends processing.

Next, a case will be described where the user selects the method in which the scanner is used and processing proceeds to step S1106. In step S1106, the CPU 201 displays a test page setting screen 1201d (FIG. 12D) generated by the UI control unit 302 on the operation unit 204, and receives an input from the user. The test page setting screen 1201d is similar to the test page setting screen 1001c, and therefore the description thereof will be omitted.

In step S1107, the CPU 201 displays the paper feed stage selection screen 1201b in FIG. 12B generated by the UI control unit 302 on the operation unit 204, and receives an input from the user. The control to be performed is similar to that in step S1103, but the processing performed when the print button 1210 is operated is different. When the CPU 201 detects that the print button 1210 has been operated with any paper feed stage selected, the CPU 201 performs control to print, from the printer 100, the test page set on the test page setting screen 1201d.

In step S1108, the CPU 201 prints a number of test pages corresponding to the setting location (a feeder 1222 or a platen 1223) set in step S1106 from the printer 100, the number being set in a test page output count 1224, and thereafter processing proceeds to step S1109. In step S1109, the CPU 201 displays a test page reading screen 1201e (FIG. 12E) on the operation unit 204. The control to be performed is similar to that in step S909, and therefore the description thereof will be omitted.

In step S1110, the CPU 201 detects that a reading start button 1230 has been operated after the printed test pages have been set in the test page setting location (the feeder 1222 or the platen 1223) set by the user in step S1108. When the CPU 201 detects that the reading start button 1230 has been operated, the CPU 201 reads the test pages from the set location of the scanner unit 202. This processing is the same as in step S910.

In step S1111, the CPU 201 and the image adjustment value determination unit 306 analyze the images on the test pages read in step S1110 and update the image position adjustment values. The method of acquiring registration adjustment values from test pages for image position adjustment is a well-known technique, and therefore the description thereof will be omitted here. The CPU 201 stores the acquired registration adjustment values in the adjustment values 1304, stores them in the paper feeding unit information storage unit 308, and ends processing.

### Method for Determining Image Position Adjustment Values at Printing

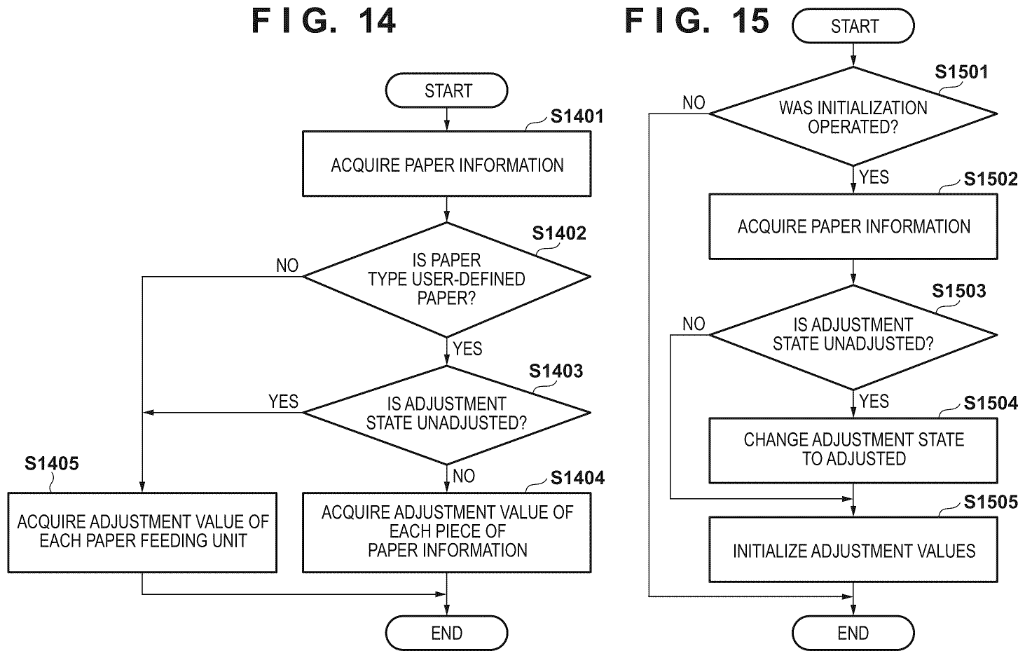

The procedure performed by the image adjustment value determination unit 306 to determine adjustment values for adjusting an image printing position misalignment during printing will be described with reference to FIG. 14. The processing according to the flowchart in FIG. 14 is realized by the CPU 201 of the controller unit 200 loading a program stored in the ROM 206 into the RAM 207 and executing the program.

In step S1401, the CPU 201 acquires paper information 601b of the paper to be used for printing, from the paper information storage unit 303. In step S1402, the CPU 201 determines whether the paper type is a user-defined paper or not (basic paper type) from the type 610 of the paper information 601b acquired in step S1401. If the CPU 201 determines that the paper type is a user-defined paper, processing proceeds to step S1403. If the CPU 201 determines that the paper type is not a user-defined paper (NO), i.e., it is a basic paper, processing proceeds to step S1405.

In step S1403, the CPU 201 determines whether the adjustment state 619 of the paper information 601b acquired in step S1401 is “adjusted” or “unadjusted”. If the CPU 201 determines that the state is “adjusted” (YES), processing proceeds to step S1404, and if the CPU 201 determines that the state is “unadjusted” (NO), processing proceeds to step S1405.

If the adjustment state 619 is “adjusted”, the adjustment values for each paper feeding unit are not to be used, and therefore, in step S1404, the CPU 201 acquires the adjustment values 615, 616, 617, and 618 for the pieces of paper information from the paper information storage unit 303, and ends processing. On the other hand, if the adjustment state 619 is “unadjusted”, in step S1405, the CPU 201 acquires the adjustment values 1304 for each paper feeding unit from the paper feeding unit information storage unit 308, and ends processing.

As described above, in the present embodiment, the CPU 201 performs image adjustment with an appropriate image position adjustment values when printing is to be performed, by switching between the image position adjustment values (615 to 618) for each piece of paper information and the image position adjustment values 1304 for each paper feeding unit depending on whether the adjustment state 619 is adjusted or not. As a result, even if the user performs paper setting on any paper feeding unit without being aware of image adjustment information, the system selects an appropriate combination of pieces of image adjustment information, and correct image adjustment is performed when printing is performed. Although the present embodiment describes the image position adjustment values, adjustment values for each piece of paper information and adjustment values for each paper feeding unit other than the image position adjustment values and may also be used.

### Second Embodiment

Next, a second embodiment will be described with reference to FIG. 15. In step S904 of the flowchart in FIG. 9, when the user intentionally uses the initial values as the adjustment values, the user may operate the adjustment value initialization button 1011 on the image position adjustment screen 1001b to initialize the adjustment values for each paper type. However, in the first embodiment, if the adjustment values are the initial values, it is determined that the adjustment values are unadjusted, so if the image position adjustment values for each paper type are initialized, the adjustment values for each paper feeding unit are applied in step S1403 and S1405 of the flowchart in FIG. 14. Therefore, in the second embodiment, when the adjustment values for each piece of paper information are initialized, the adjustment state is set to “adjusted” and the initial values for each paper type are applied as the adjustment values.

The processing according to the flowchart in FIG. 15 is realized by the CPU 201 of the controller unit 200 loading a program stored in the ROM 206 into the RAM 207 and executing the program. In step S1501, the CPU 201 determines whether or not the adjustment value initialization button 1011 has been operated on the image position adjustment screen 1001b (FIG. 10B). If the CPU 201 determines that the adjustment value initialization button 1011 has not been operated, the CPU 201 ends processing, and if the CPU 201 determines that the adjustment value initialization button 1011 has been operated, processing proceeds to step S1502.

In step S1502, the CPU 201 reads out the paper information 601b stored in the HDD 208. In step S1503, the CPU 201 determines whether the adjustment state 619 of the read paper information 601b is “unadjusted” or “adjusted”. If the CPU 201 determines that the state is “adjusted” (NO), processing proceeds to step S1505 without performing the processing in step S1504, and if the CPU 201 determines that the state is “unadjusted” (YES), processing proceeds to step S1504. In step S1504, the CPU 201 changes the adjustment state 619 to “adjusted”, and stores it in the paper information storage unit 303.

In step S1505, the CPU 201 changes the adjustment values 615, 616, 617, and 618 to their initial values, and stores them in the paper information storage unit 303. As described above, in the present embodiment, when the CPU 201 initializes the adjustment values for each piece of paper information, the CPU 201 changes the adjustment state to “adjusted” and acquires the adjustment values for each piece of paper information as the initial values, thereby enabling appropriate image position adjustment even when the user intentionally uses the initial values.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-151543, filed Sep. 19, 2023 which is hereby incorporated by reference herein in its entirety.

What is claimed is:

1. An image forming apparatus comprising:
at least one processor that causes the image forming apparatus to function as:
a first setting unit configured to set one or more adjustment values for image formation to a sheet feeding unit;
a second setting unit configured to set one or more adjustment values for image formation to a sheet; and
a control unit configured to perform control to form an image on the sheet using the adjustment values for image formation set to the sheet by the second setting unit in the case where the adjustment values for image formation have been set to the sheet by the second setting unit, and to perform control to form an image on the sheet using the adjustment values for image formation set to the sheet feeding unit by the first setting unit in the case where the adjustment values for image formation have not been set to the sheet by the second setting unit.

2. The image forming apparatus according to claim 1, further comprising
a memory configured to store information indicating that the adjustment values for image formation have been set to the sheet,
wherein the control unit determines whether or not the adjustment values for image formation have been set to the sheet, based on the information stored in the memory.

3. The image forming apparatus according to claim 1,
wherein the control unit determines whether or not the sheet is a user-defined paper registered in the image forming apparatus by a user,
in the case where the control unit determines that the sheet is not the user-defined paper, the control unit performs control to form an image on the sheet using the adjustment values for image formation set to the sheet feeding unit by the first setting unit,
in the case where the control unit determines that that sheet is the user-defined paper and the adjustment values for image formation have been set to the sheet, the control unit performs control to form an image on the sheet using the adjustment values for image formation set to the sheet by the second setting unit, and
in the case where the control unit determines that the sheet is the user-defined paper and the adjustment values for image formation have not been set to the sheet when an image is to be formed on the sheet housed in the sheet feeding unit, the control unit performs control to form an image on the sheet using the adjustment values for image formation set to the sheet feeding unit by the first setting unit.

4. The image forming apparatus according to claim 1,
wherein the adjustment values are adjustment values for an image formation position.

5. The image forming apparatus according to claim 1,
wherein the adjustment values include one or more adjustment values for an image formation position on a first side of the sheet and one or more adjustment values for an image formation position on a second side of the sheet.

6. The image forming apparatus according to claim 1,
wherein the second setting unit further sets a grammage of the sheet and a surface property of the sheet to the sheet.

7. A control method for controlling an image forming apparatus, the control method comprising:
a first setting step of setting one or more adjustment values for image formation to a sheet feeding unit;
a second setting step of setting one or more adjustment values for image formation to a sheet; and
a control step of performing control to form an image on the sheet using the adjustment values for image formation set to the sheet in the second setting step in the case where the adjustment values for image formation have been set to the sheet in the second setting step, and performing control to form an image on the sheet using the adjustment values for image formation set to the sheet feeding unit in the first setting step in the case where the adjustment values for image formation have not been set to the sheet in the second setting step.

8. A non-transitory computer readable storage medium that stores a computer program for causing a computer to perform a control method for controlling an image forming apparatus, the control method comprising:
a first setting step of setting one or more adjustment values for image formation to a sheet feeding unit;
a second setting step of setting one or more adjustment values for image formation to a sheet; and
a control step of performing control to form an image on the sheet using the adjustment values for image formation set to the sheet in the second setting step in the case where the adjustment values for image formation have been set to the sheet in the second setting step, and performing control to form an image on the sheet using the adjustment values for image formation set to the sheet feeding unit in the first setting step in the case where the adjustment values for image formation have not been set to the sheet in the second setting step.
